(19) United States
(12) Patent Application Publication
(10) Pub. No.: US 2014/0116213 A1
(43) Pub. Date: May 1, 2014

(54) APPARATUS FOR CUTTING FOOD PRODUCT

(71) Applicant: Urschel Laboratories, Inc., Valparaiso, IN (US)

(72) Inventors: Daniel Wade King, Valparaiso, IN (US); Michael Scot Jacko, Valparaiso, IN (US)

(73) Assignee: Urschel Laboratories, Inc., Valparaiso, IN (US)

(21) Appl. No.: 14/066,530

(22) Filed: Oct. 29, 2013

Related U.S. Application Data
(60) Provisional application No. 61/719,588, filed on Oct. 29, 2012.

(51) Int. Cl. B26D 7/06

(52) U.S. Cl. CPC B26D 7/0691
USPC 83/13; 83/403

(57) ABSTRACT

An impeller for use in a food cutting apparatus. The impeller is adapted to be mounted coaxially within a cutting head having one or more cutting knives disposed about a circumference thereof. The impeller is equipped with paddles such that, as the impeller rotates within the cutting head, the paddles force food product radially outward toward the stationary cutting knives of the cutting head. The paddles are equipped with grooves on at least one face thereof. The grooves preferably extend across the entire surface of the paddle face for the purpose of promoting the stability of the food product relative to the impeller.

### CROSS REFERENCE TO RELATED APPLICATIONS

This application claims the benefit of U.S. Provisional Application No. 61/719,588, filed Oct. 29, 2012. In addition, this application is related to U.S. patent application Ser. No. 11/696,961, filed Apr. 5, 2007, now U.S. Pat. No. 7,658,133, which claims the benefit of U.S. Provisional Application No. 60/745,028, filed Apr. 18, 2006. The contents of these prior patent documents are incorporated herein by reference.

### BACKGROUND OF THE INVENTION

The present invention generally relates to cutting methods and cutting devices. More particularly, this invention relates to an impeller which, by rotating, is adapted to move food products radially outward towards one or more stationary cutting knives.

Current methods of cutting root vegetables, such as carrots or potatoes, into smaller slices or “chips” include those that make use of an impeller, such as an impeller 10 of the type represented in FIG. 1, and one or more stationary cutting blades (knives). The impeller 10 of FIG. 1 is configured to be placed within a ring-shaped cutting head (not shown), also referred to as a slicing case, or case, or casing. A nonlimiting example of a cutting head 12 is represented in FIG. 4 as comprising any number of cutting knives 14 arranged along its circumference. The impeller 10 is configured to be mounted coaxially within the cutting head 12 such that, when the impeller 10 rotates, the outer circumferential edge of the impeller 10 is constantly in close proximity to each cutting knife 14 of the cutting head 12.

Food product placed within the impeller 10 are forced radially outward towards the stationary cutting knives 14 by the rotation of the impeller 10. Paddles 16 of the type represented in FIG. 1, and more closely shown in FIGS. 2 and 3 (perspective and cross-sectional views, respectively), are adapted to position and stabilize the food product at the outer circumferential edge of the impeller 10. The rotation of the impeller 10, along with the force of contact with the paddles 16, forces the food product against and into engagement with the stationary cutting knives 14. In this way, food product can be cut (for example, sliced, diced, or shredded) into smaller pieces of consistent size and thickness.

While impellers of the type shown in FIGS. 1 through 3 are widely used in combination with cutting heads of the type represented in FIG. 4, under certain conditions a food product may have a tendency to rotate about its own axis while engaged by one of the paddles, particularly if the product is spherical or cylindrical and relatively large. This is undesirable if the desire is for a sliced, diced or shredded product of consistent thickness and shape. In addition, issues relating to waste and scrap reduction, cleanliness, and machine life expectancy can be addressed to some extent by preventing the food product from rotating about its own axis.

In view of the above, it can be appreciated that it would be desirable if an improved cutting apparatus were available that was capable of keeping relatively large spherical or cylindrical food products stationary relative to the impeller while in contact with the paddle and during and between engagements with a cutting device.

### BRIEF DESCRIPTION OF THE INVENTION

The present invention provides a cutting apparatus comprising an impeller which, by rotating, moves food products radially outward towards one or more stationary cutting knives, wherein the impeller includes paddles suitable for keeping the food product stationary and motionless relative to the impeller while in contact with the paddles.

According to a first aspect of the invention, an impeller for use in a food cutting apparatus is adapted to be mounted coaxially within a cutting head having one or more cutting knives disposed about a circumference thereof and includes paddles such that, as the impeller rotates within the cutting head, the paddles force food product radially outward toward the stationary cutting knives of the cutting head. The paddles are equipped with grooves on at least one face thereof. The grooves preferably extend across the entire surface of the paddle face for the purpose of promoting the stability of the food product relative to the impeller.

A technical effect of the invention is that rotation of the food product within the cutting apparatus relative to the paddles of the impeller can be significantly reduced, particularly in the case of relatively large spherical or cylindrical food products. In particular, it is believed that, by providing a grooved paddle of the type described herein, a food product can be maintained substantially motionless relative to the paddle.

Other aspects and advantages of this invention will be better appreciated from the following detailed description.

### BRIEF DESCRIPTION OF THE DRAWINGS

FIG. 1 illustrates an impeller of a type known in the art and equipped with smooth-faced paddles.

FIG. 2 shows a close-up view of a paddle of the impeller of FIG. 1.

FIG. 3 shows a cross-sectional view of a paddle of the impeller of FIGS. 1 and 2.

FIG. 4 represents a cutting head of a type known in the art for use in combination with the impeller of FIGS. 1 through 3.

FIG. 5 represents an impeller similar in configuration to the impeller of FIG. 1, but modified to have paddles with grooved faces in accordance with an embodiment of the current invention.

FIG. 6 shows a close-up view of a grooved paddle of the impeller of FIG. 5.

FIG. 7 shows a cross-sectional view of a grooved paddle of the impeller of FIGS. 5 and 6.

### DETAILED DESCRIPTION OF THE INVENTION

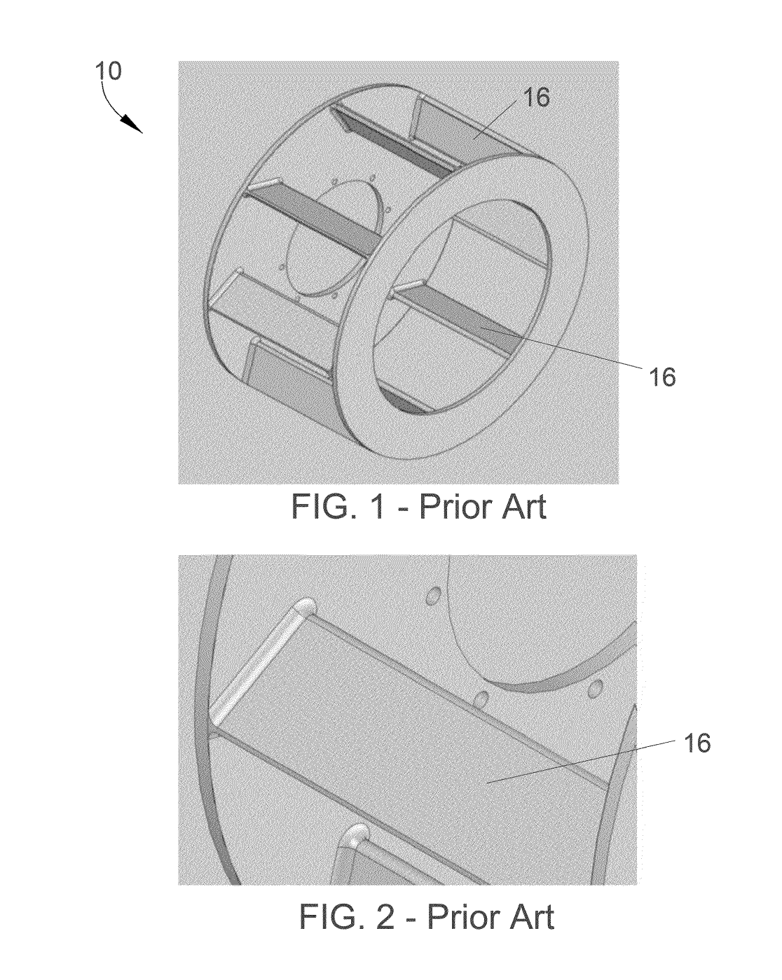

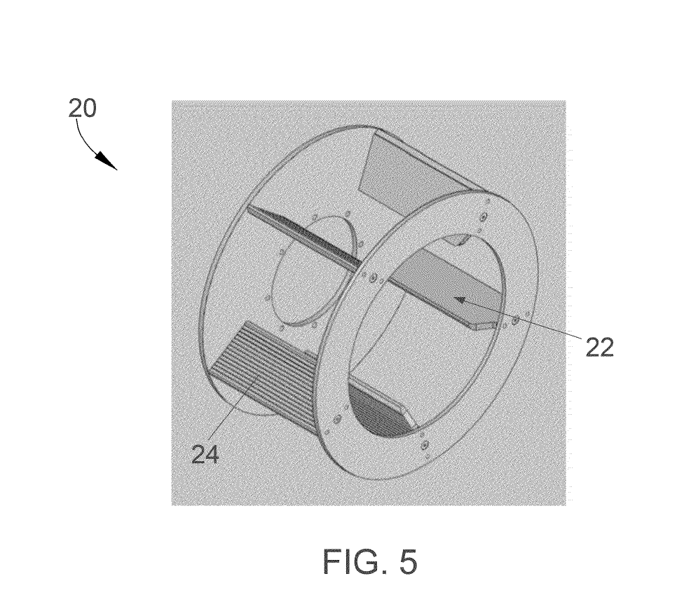

The present invention describes an impeller suitable for use in a food product cutting apparatus. For example, the current invention encompasses adaptations or improvements to impeller designs of the type represented in FIG. 1 and adapted to operate in combination with cutting heads of the type represented in FIG. 1. An embodiment of an impeller 20 of this invention is represented in FIG. 5, wherein the impeller 20 preferably has a generally circular shape and is configured to be placed coaxially within a cutting head (not shown) at whose circumference any number of cutting blades (knives) are secured, typically oriented to be parallel to the axis of the impeller 20. The impeller 20 shares certain features of the type described for impellers disclosed in U.S. Pat. No. 7,658,133, including paddles 22 that extend to the outer circumference of the impeller 20. However, the impeller 20 is further modified to inhibit rotation of relatively large round and cylindrical food products while engaged with a paddle 22 of the impeller 20.

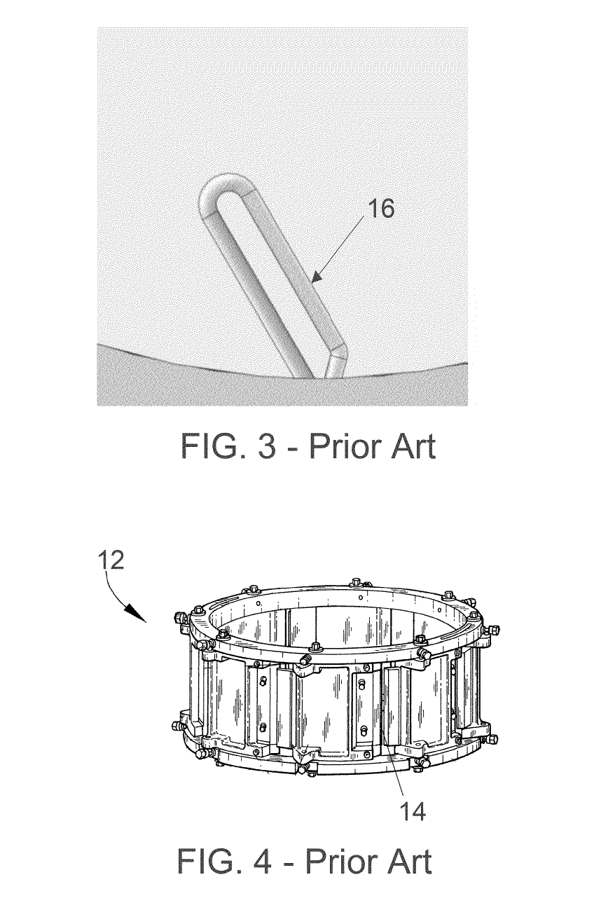

Consistent with the previous discussion of FIGS. 1 through 4, the impeller 20 represented in FIG. 5 is adapted to rotate coaxially within a cutting head, such that the outer circumference of the impeller 20 is in close proximity to the stationary inner circumference of the cutting head. A cutting apparatus comprising the impeller 20 may be oriented so that the impeller 20 has a vertical axis of rotation, as described in U.S. Pat. No. 7,658,133, or oriented so that the impeller 20 has an axis of rotation other than vertical. As the impeller 20 rotates within the cutting head, the impeller 20 forces food products placed therein radially outward towards the outer circumference of the impeller 20 and into engagement with the cutting knives disposed at the inner circumference of the cutting head. The paddles 22, located adjacent the outer circumference of the impeller 20, serve to position and stabilize the food products relative to the rotation of the impeller 20. As most evident from FIG. 7, each paddle 22 may be disposed at an angle relative to a radial that passes through the axis of rotation of the impeller 20, such that the paddles 22 capture and cradle the food products against the cutting edges of the knives. The paddles 22 cause each food product to sequentially engage the cutting knives, which are oriented so that their cutting edges extend in a direction approximately opposite the direction of rotation of the impeller 20.

The movement of each paddle 22 relative to each cutting knife causes portions of a food product held by the paddle 22 to be sliced. In order to produce portions of consistent size and shape, the food product must remain stable and essentially motionless relative to the impeller. However, as the impeller 20 rotates, friction between the food product and the inner circumference of the cutting head, as well as the opposing force applied to the food product as it engages each knife, can cause the food product to counter-rotate against the face 24 of a paddle 22 engaging the food product. If the axis of rotation is other than vertical, gravity can further affect the cutting process depending on the instantaneous position of the food product in the cutting head. Such dynamics are further aggravated if the food products being processed are relatively large and round or cylindrical.

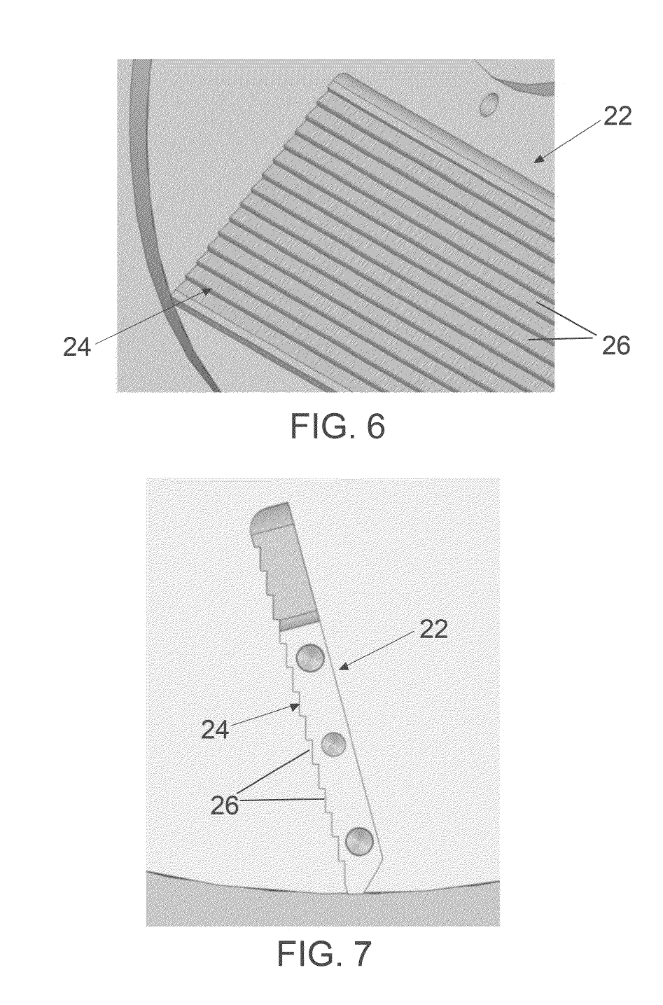

According to a preferred aspect of the invention, improved stability of the food product during the slicing operation is accomplished by defining grooves 26 in the faces 24 of the paddles 22 that contact the food products. In the example of FIG. 5, the grooves 26 are disposed such that the impeller 20 would rotate clockwise from the perspective of an observer positioned to the right of the impeller 20. Suitable but nonlimiting embodiments of grooves 24 are represented in more detail in FIGS. 6 and 7. As evident from FIGS. 5 through 7, the grooves 26 are oriented transverse to radials of the impeller 20, and are preferably aligned parallel to the axis about which the impeller 20 rotates. Furthermore, the grooves 26 are shown as fully extending to the absolute axial ends of the paddles 22 (in the axial direction of the impeller 20) as well as fully extending to the absolute radial ends of the paddles 22 (in the radial direction of the impeller 20). The pitch, depth, angle, and quantity of the grooves 26 are adapted to maintain the food product stable and relatively motionless while contacted by the paddle 22 and during the cutting operation performed by each knife. Such variations may be made with consideration for the specific application of the impeller 20, and more particularly, the size, shape, and weight of the food product being processed and/or the intended sliced, diced or shredded product of the cutting apparatus.

To effectively maintain the orientation of relatively large round or cylindrical food products relative to the cutting knives, the example of the grooves 26 shown in FIGS. 6 and 7 has a sawtooth profile in which the individual teeth (peaks) of the grooves 26 project in the radially outward direction of the impeller 20, a first face of each tooth approximately lies on a radial of the impeller 20, and the second face of each tooth is approximately perpendicular to the first face, i.e., essentially parallel to a tangent to the circumference of the impeller 20. With this configuration, the paddles 22 are particularly adapted to aggressively minimize any motion of a relatively large food product, and particularly food products that are larger and more flexible than potatoes, a nonlimiting example of which are beets having sizes over a range of about two to eight inches (about 5 to 20 cm) in diameter. By extending the grooves 26 to the extremities of the paddles 22, the grooves 26 may also be able to provide the additional advantage of lengthening the life of the paddles 22 by preventing food product from collecting on the paddles 22. The impeller 20 is particularly well suited for dicing beets while the axis of rotation of the impeller 20 is substantially horizontal, resulting in the food products being subjected to variations in the influence of gravity and subjected to greater friction and slicing forces that are more likely to result in an undesirable counter-rotation of the food product.

While the invention has been described in terms of a specific embodiment shown in FIGS. 5 through 7, it is apparent that other forms could be adopted by one skilled in the art. For example, the impeller, impeller paddles, and grooves could differ in appearance and construction from the embodiment shown, the impeller and paddles could be fabricated from a variety of materials, and the impeller, paddles, and grooves could be produced using various processes. Therefore, the scope of the invention is to be limited only by the following claims.

1. A cutting apparatus comprising an impeller coaxially mounted within a cutting head comprising one or more cutting knives disposed along a circumference thereof, the impeller being adapted to rotate within the cutting head so that an outer circumference thereof is adjacent the circumference of the cutting head, the impeller comprising:
paddles for delivering and forcing food products radially outward toward the cutting knives as the impeller rotates within the cutting head, each of the paddles extending to the outer circumference of the impeller; and
grooves defined on at least a first face of each of the paddles, the grooves being substantially parallel to each other and orientated substantially parallel to an axis of rotation of the impeller, the grooves being disposed over the entire axial and radial extents of the first face of each paddle.

2. The cutting apparatus of claim 1, wherein the grooves have a sawtooth profile.

3. The cutting apparatus of claim 2, wherein the grooves comprise individual teeth and the peaks thereof project in a radially outward direction of the impeller.

4. The cutting apparatus of claim 3, wherein each of the teeth has a first face that approximately lies on a radial of the impeller and a second face that is approximately perpendicular to the first face.

5. The cutting apparatus of claim 1, wherein the axis of rotation of the impeller is horizontal.

6. A method of operating the cutting apparatus of claim 1, the method comprising placing a food product in the impeller as the impeller rotates within the cutting head, the paddles delivering and forcing the food product radially outward into engagement with the cutting knives, and the grooves stabilizing and preventing rotation of the food product during engagement thereof with the cutting knives.

7. The method of claim 6, wherein the food product has a size of about 5 to about 20 centimeters in diameter.

8. The method of claim 7, wherein the food product is a beet.

9. The method of claim 7, wherein the method dices the food product.
